(19) United States
(12) Patent Application Publication
(10) Pub. No.: US 2009/0157504 A1
(43) Pub. Date: Jun. 18, 2009

(54) System and method for advertising to a target demographic of internet users

(76) Inventors: Christian Nielsen Braemer, La Jolla, CA (US); Thomas William Kestas, San Diego, CA (US)

Correspondence Address: DICKSTEIN SHAPIRO LLP, 1825 EYE STREET NW, Washington, DC, 20006-5403, US

(21) Appl. No.: 12/000,517

(22) Filed: Dec. 13, 2007

(51) Int. Cl. G06Q 30/00; G06F 15/16

(52) U.S. Cl. 705/14; 705/1; 709/217

(57) ABSTRACT

A method for directing push media content to specific users logged on to a local TCP/IP network using a network of servers and software. The invention employs user profile input and advertiser specified target demographic criteria to show specific media content to internet users advertisers wish to reach.

### FIELD OF THE INVENTION

The present invention relates to methods of targeted advertising to internet users on a wireless local area network.

### BACKGROUND

There exists a demand for internet access in various public and private locations. Various businesses, such as coffee shops, restaurants, and others, provide internet access to their customers to increase the number of customers who frequent the businesses and the amount of time the customers spend at the business. Currently, conventional systems are known in which advertisers will pay businesses or a service to show advertisements to the customers using the internet at a particular location. The customer watches the advertisements in exchange for internet access. However, an advertiser advertising with such a system would have no way to determine whether their advertisements were being shown to a target demographic of internet users.

### SUMMARY OF THE INVENTION

Various embodiments of the present invention are directed to a system and method of directing advertising content to a target demographic using a communication network. In one embodiment, a method for advertising to a target demographic of internet users comprises three main steps: 1) advertisers upload advertising content to a communication network and specify a target demographic to which the advertising content should be shown; 2) users log on to the communications network from a computer on which the user's demographic information is tied to a unique network interface hardware address; and 3) the communication network retrieves and sends the advertising content to the computer of users having demographic information matching the target demographic, which is shown to the user before granting internet access. Advertisers are therefore able to ensure that their chosen advertising content is reaching the desired demographic internet users.

### BRIEF DESCRIPTION OF THE DRAWINGS

FIG. 1 is a schematic diagram of a communications network according to an embodiment described herein.

FIG. 2 is a flow chart of a method according to an embodiment described herein.

### DETAILED DESCRIPTION OF THE INVENTION

In the following detailed description, reference is made to various specific embodiments that may be practiced. These embodiments are described with sufficient detail to enable those skilled in the art to practice them. It is to be understood that other embodiments may be employed.

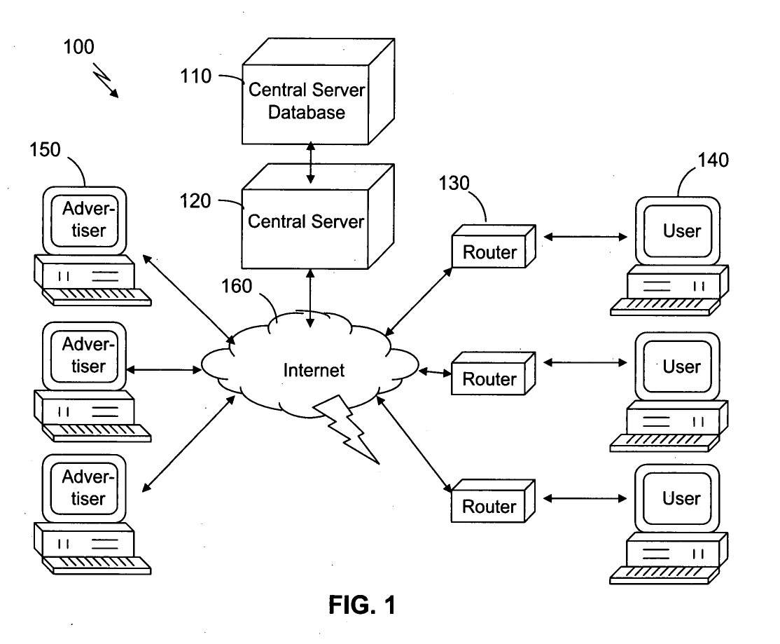

FIG. 1 is a schematic diagram of a communications network 100 according to an embodiment of the invention. The communications network 100 includes a central server 120, a central server database 110, and at least one router 130. In various embodiments, the communication network 100 may include a plurality of servers 120, a plurality of server databases 110, and/or a plurality of routers 130.

As will be described in greater detail below, the routers 130 are remote wireless nodes that are captive portals arranged at various remote locations. The routers 130 act to facilitate a local Transmission Control Protocol (TCP) and Internet Protocol (IP) network (collectively referred to herein as the “TCP/IP network”), through which users may access the Internet 160 using user computers 140. A user computer 140 is defined as any type of electronic device capable of communication with a local TCP/IP network connected to the Internet 160, such as personal computers, personal digital assistants (PDA's), cellular telephones, smart-phones, video games, MP3 players, and the like. In like embodiments, therefore, the routers 130 may be devices having a combination of hardware and software that act to establish a local TCP/IP network to allow some or all of the various types of user computers 140 to access the Internet 160.

In one embodiment, the routers 130 may facilitate a Wireless Local Area Network (WLAN) to allow user computers 140 to access the Internet 160 using known wireless protocols for personal computers, such as Wi-Fi, Wi-Max, or Bluetooth technologies. In another embodiment, the routers 130 may be consumer routers that are re-flashed with custom firmware, i.e., embedded software. In another embodiment, the routers 130 may be satellites orbiting the Earth in a geostationary orbit and used to establish a wireless TCP/IP network over a broad region. In other various embodiments, the local TCP/IP network may be a hardwired local network into which a user would physically connect a user computer 140, such as an Ethernet or other network connected by cables such as conductors, fiber optics, or the like.

The central server 120 is a computer that facilitates the transfer of data between users, advertisers, the Internet 160, and the central server database 110. The central server database 110 is a memory storage unit or a plurality of memory storage units that store data from the users and advertisers. The central server database 110 may be located locally or remotely from the central server 120. The various components of the central server 120, for example, a radius server for allowing remote access dial-up, may be physically located in the same place or may be located remotely from each other.

The advertiser computers 150 may be any type of electronic device capable of transmitting advertising content to the central server 120, such as personal computers, servers, personal digital assistants (PDA's), cellular telephones, smart-phones, video games, MP3 players, and the like.

The functions of the central server 120, the central server database 110, and the advertiser computers 150 are described in greater detail below in relation to various method embodiments.

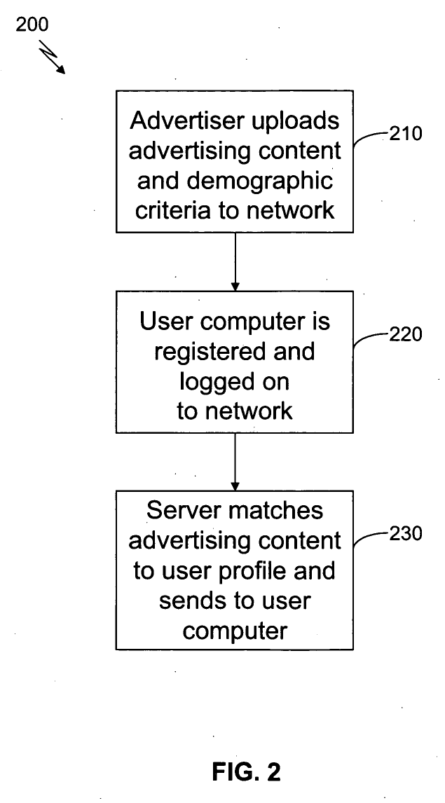

FIG. 2 is a flow chart showing a method 200 of operating the communications network 100 according to an embodiment of the present invention. The communications network 100 is administered by a service provider. In alternative embodiments of the invention, the communications network 100 may include one local TCP/IP network or many local TCP/IP networks throughout a geographic region. One service provider may administer the entire communications network 100 or alternatively, communications network 100 may be licensed out to many different service providers.

In step 210 of the method 200, an advertiser, using an advertiser computer 150, accesses the communications network 100 through the central server 120 and uploads advertising content, also known as push media content, to be stored in the central server database 110. An advertiser may be any person or organization wishing to provide information to users.

In one embodiment, the advertiser computers 150 may access the central server 120 through the central server's internet interface. In another embodiment, the advertising computers 150 may be omitted from the method and an advertiser may upload advertising content to the central server 120 directly by uploading advertising content using a portable memory device, such as a floppy disk, CD, DVD, memory stick, portable hard drive, jump drive, or the like, and a portable memory device reader connected to the central server 120.

In one embodiment of the invention, the network 100 may be configured so that advertisers may access the network 100 in an automated fashion. An advertiser may access the central server 120 from their own advertiser computer 150 to create an advertiser account. The advertiser may then upload the advertising content that they would like their target audience to see to the central server database 110.

The advertiser computers 150 may be administered by the companies selling or making the product or service to be advertised, advertising agencies, third party advertising services, the communication network administrator, or others. If the advertising is coordinated by the communication network administrator, the advertising computers 150 may be combined with the central server 120.

In another embodiment, an advertiser may store the advertising content on their own database or a third party database and route the advertising content through the central server 120 to users. The central server 120 may embed links to the advertiser database. The advertiser may then create their own demographic target profile as described above to determine to which user profiles the advertising content will be sent.

The advertising content may be any type of media presentation designed to impart information to users, and may include audio, video, animation, still pictures, or a combination thereof. The advertising content may be in the form of traditional internet advertisements, such as leaderboards, banners, buttons, rectangles, pop-ups, skyscrapers, microbars, etc. In one embodiment, the advertising content may be in the form of a survey, which a user must complete. In another embodiment, the advertising content may be commercials having audio and/or video components, and having a length in time of between ten to ninety seconds. Of course, longer or shorter commercials are also possible. The commercials having audio and/or video components may be in a format such as Flash Video, which is the name of a file format used to deliver video over the Internet using Adobe Flash Player (formerly known as Macromedia Flash Player) version 6, 7, 8, or 9. Flash Video files contain video bit streams which are a variant of the H.263 video standard, under the name of Sorenson Spark. The advertising content may be served as streaming media from an advertiser computer 150 that includes a streaming media server.

In addition to advertising content, advertisers may also submit demographic criteria. Demographic criteria is defined as information describing what personal attributes the advertiser wishes a user who views the advertiser's advertising content to have. The demographic criteria may include, but is not limited to, a criteria or combination of criteria such as information relating to the date and/or time of internet use, frequency of internet use, age, gender, ethnicity, race, sexual orientation, interests or hobbies, marital status, family status, income, education level, location of residence, and current location. Demographic criteria may also include information relating to online behavior, such as the types of websites viewed. For example, a luxury car dealership may want to show advertising content to users who have accessed other luxury car or business websites.

The demographic criteria may be very general, i.e., by including a range or multiple ranges, or may be very specific, i.e., by including only a single data point. For example, demographic criteria may specify that a user must be of an age range between 18 to 30 years old to receive certain advertising content. As another example, demographic criteria may specify that a user must be exactly 21 years old to receive certain advertising.

The demographic criteria may also include to which locations, i.e., which local TCP/IP networks, the advertising content should be shown. In one embodiment, the advertiser may specify each location at which the advertising content will be shown. In another embodiment, the advertiser may specify regions, such as neighborhoods, municipalities, counties, regions, states, and the like, at which the advertising content will be shown. In various other embodiments, an advertiser may specify a combination of demographic criteria such that advertising content is shown to users having different demographic criteria in different locations to target a certain demographic over a larger geographic region. For example, a shoe store catering to young adults may wish to advertise to internet users that visit www.myspace.com or www.facebook.com within 10 miles of the local university.

In other embodiments, the local TCP/IP networks may be strategically located near or within certain business establishments that cater to an advertiser's target demographic. For example, a local TCP/IP network could service an entire shopping mall, allowing mall vendors to advertise to wireless internet users within the mall. Other locations, such as restaurants, cafes, airports, universities, and neighborhood public spaces, may also advertise to wireless internet users in the immediate surroundings.

The advertisers may be charged based on network availability, number of local TCP/IP networks or the size of the geographic area to which they would like to advertise, the complexity of their target demographic criteria, or a combination thereof. In other embodiments, an advertiser may be charged based on the number of times an advertising content is shown. In one embodiment, the amount of payment per advertising content shown is based on how closely a user profile meets an advertiser's demographic criteria, and therefore, how likely the user is to use the advertiser's product or service.

In step 220 of the method 200, each user logs the user computer 140 onto the network. Software on the routers 130 marshal the user computer 140 connections and directs the user computer's internet web browsers to a website hosted by the central server 120. If a user has not previously done so, the user registers the user computer 140 with the network 100 using a registration process to create a user profile that is linked to the user computer 140. If the central server 120 does not recognize the user computer 140 as having previously been registered, the central server 120 initiates a registration process. The central server 120 serves a series of demographic questions to the user computer 140 for the user to answer. The demographic questions relate to personal attributes of the user which correlate to the demographic criteria available to an advertiser to designate a demographic profile in a given embodiment. Any number of demographic questions may be sent to a user computer 140 for completion by a user. In one embodiment, the questions include only a short series of questions, i.e., between one and ten questions, so that a user will not become frustrated with the registration process. As part of a user profile, the central server 120 may also require a user to designate a user name, which may be the user's legal name or may be a user chosen nickname or other identifier.

If the central server 120 authenticates a user computer 140 against an existing user profile as having previously registered, the central server 120 may allow the user computer 140 to bypass the registration process. In one embodiment, the central server 120 may not require a registered user computer 140 to take any additional actions. In another embodiment, the central server 120 may require or make optional a process in which a user updates the their user profile from the registered user computer 140. For example, if a user has changed their residence to a different geographical location, for example, from New York to California, the user may update their user profile information to receive advertising content relevant to their new geographic location on their registered user computer 140.

The user profile may include other information previously stored on the user computer 140, such as information relating to internet use. The information relating to internet use may include information saved by a user's web browser that tracks internet use, such as “HTTP cookies,” web browsing history, favorite web sites, IP address, URL query strings, hidden form fields, Macromedia Flash local stored objects, and the like. The information relating to internet use may be collected from a user computer 140 during the registration process and/or may be updated each time a user logs on to the network 100 and/or may be updated periodically or continuously during a user's network session.

In another embodiment, a series of sensors may be located with the area covered by the local TCP/IP network to detect electronic devices carried by a user that emit a radio frequency, such as cellular telephones, PDA's, RFID tags, electronic car keys, and the like. The series of sensors may transmit this information to the central server 120 where the information may be added to the user profile. For example, if the user is detected to be carrying a cellular telephone from a particular cell phone service provider, advertising content from that particular cell phone provider may be served to the user computer 140.

In addition or alternatively to collecting saved information regarding past internet use, the central server 120 may record information regarding a user's internet activity, or on-line behavior, for the duration of the internet session. The internet activity information may include information such as the URL addresses visited, the frequency of visits, and the duration of visits. This information acquired during the internet session, and each successive session, may be added to the user's profile to build upon the individual user's user profile. With each successive log on to the network, the user's user profile will become increasingly specific, and allow for more efficient targeted advertising.

The user profile is then sent to the central server 120 where it is stored in the central server database 110. Additionally, a computer identifier is also sent from the user computer 140 to the central server database 110. In one embodiment, the computer identifier is sent from the user computer 140 to the central server database 110 when the user computer 140 first makes contact with the communication network 100.

A computer identifier may be any type of information that identifies a user computer 140 or a hardware component of a user computer 140. In one embodiment, the computer identifier may be related to communication hardware included with the computer and used to communicate with the communications network 100. For example, the computer identifier may be a network card Media Access Control address (MAC address), an Ethernet Hardware Address (EHA), a hardware address, an adapter address, or the like, which identifies an individual network card used to access the local TCP/IP network. Other computer identifiers may also be used, including other universally administered addresses, also known as “burned-in addresses,” that are uniquely assigned to a hardware device by its manufacturer.

The central server 120 links the computer identifier to the user profile entered by the user of the user computer 140. Therefore, each time a user logs on to the communications network 100 using the user computer 140, the central server 120 may associate a user profile with a user computer 140. The computer identifier may be stored in the central server database 110 as part of the user profile or may merely be linked, or correlated, to the user profile. In one embodiment, each user profile is associated with only one computer identifier. In another embodiment, a user profile may be associated with multiple computer identifiers, and therefore, multiple computers, which may be the same or different type of computer.

In step 230 of the method 200, the central software determines what advertising content will be shown on each user computer 140 and serves the determined advertising content to the user computer 140. The software at the central server 120 matches a user profile associated with a user computer 140 with a target demographic criteria for advertising content. A user profile is matched with demographic criteria when the user profile meets whatever requirements the target demographic criteria specifies for a user profile.

When a user profile matches the target demographic criteria for a particular advertising content, the software instructs the central server 120 to retrieve and serve the advertising content to the user computer 140 through the appropriate router 130. The present invention can direct specific advertising content to individual locations simultaneously, as each router 130 has its own individual IP address.

In one embodiment, when a user profile is matched to more than one advertising content, the software at the central server 120 may serve the user computer 140 the matching advertising content that most closely matches the user profile associated with the user computer 140. In another embodiment, when a user profile is matched to more than one advertising content, the software at the central server 120 may randomly select which matching advertising content to serve the user computer 140. Alternatively, the software at the central server 120 may rotate which matching advertising content is served to the user computer 140 so that each advertising content is shown an equal number of times or a designated number of times. In yet another embodiment, the advertising content may be given a predetermined priority rank to determine which matching advertising content will take priority over other matching content to be served to a user computer 140.

In another embodiment, advertising content may be served to a device located within the local TCP/IP network that is independent from the user computer 140. The independent device may be a communication device that is arranged for communicating to multiple users within the local TCP/IP network, for example, a television set, a computer monitor, audio speakers, an electronic display board, etc. In one embodiment, the advertising content served to the independent device may be determined by an average or a compilation of the user profiles of users currently logged onto the communication network 100. In another embodiment, the independent device may be located near an exit of an establishment having the local TCP/IP network and may display an advertisement to a user after the user has exited the communication network at a time that the user is estimated to be exiting the establishment.

At some point after the advertising content has been served to the user computer 140, the user computer 140 will be granted access to the Internet 160. In one embodiment, the central server 120 instructs the router 130 to allow the user computer 140 to access the Internet 160 through the router 130 after the advertising content has been shown. In various embodiments, the advertising content can be shown in a variety of formats before and/or during the user's internet session. In a preferred embodiment, the advertising content may be shown through an internet browser. In other embodiments, the advertising content may launch its own software program.

In one embodiment, video or flash media content may be shown for a predetermined time before the user computer 140 gains access to the Internet 160. In a preferred embodiment, up to ninety seconds of advertising content will be shown to a user before the user computer 140 gains access to the Internet 160. In other embodiments, the advertising content may be shown to a user at predetermined time periods during the user's internet sessions. In yet another embodiment, advertising content, such as banners, bars, or pop-ups, may be shown in various locations, such as within the user's internet browser, over the duration of each internet session. The different types of advertising content may be shown in the appropriate context to minimize disruption to a user's internet session. For example, a cycle of banner or pop-up advertisements may appear in the user's internet browser, whereas video or flash content may be shown before the user gains access to the Internet 160.

The methods and apparatus devices described above illustrate specific embodiments of methods and devices of many that could be used and practiced. The above description and drawings illustrate embodiments, which achieve the objects, features, and advantages of the present invention. However, it is not intended that the present invention be strictly limited to the above-described and illustrated embodiments. For example, it should be noted that the various embodiments of the present invention described above can be used in combination with each other in the communications network 100. Also, it is not necessary, unless indicated otherwise above or dictated by logic, that the various steps of the method 200 be practiced in a particular order, and various steps may be repeated and/or practiced simultaneously. Additionally, any modifications, though presently unforeseeable, of the present invention that come within the spirit and scope of the following claims should be considered part of the present invention.

What is claimed is:

1. A method of providing advertising content to user computers through a communication network comprising:
creating a user profile, the user profile relating to personal attributes of a user of the communication network;
correlating the user profile to a computer identifier, the computer identifier identifying a user computer;
designating demographic criteria for advertising content;
sending the advertising content to a user computer that is identified by a computer identifier that is correlated to a user profile that matches the demographic criteria for the advertising content.

2. The method of claim 1, further comprising allowing the user computer access to the Internet after the advertising content has been sent to the user computer.

3. The method of claim 1, wherein the user profile comprises a geographic location of the user computer.

4. The method of claim 1, further comprising allowing a user to update a previously created user profile.

5. The method of claim 4, further comprising allowing a user to update the geographic location of the user's location of residence.

6. The method of claim 1, wherein the advertising content comprises a video display shown for a predetermined time and wherein the user computer is allowed access to the Internet after the predetermined time.

7. The method of claim 1, wherein the computer identifier identifies communications hardware included in the user computer.

8. The method of claim 7, wherein the computer identifier comprises a Media Access Control address.

9. The method of claim 1, wherein the user profile comprises information selected from the group consisting of time of internet use, frequency of internet use, age, gender, ethnicity, race, sexual orientation, interests, hobbies, marital status, family status, income, education level, location of residence, and current geographic location.

10. The method of claim 1, wherein the user profile comprises information gathered from transmissions output by a transmitting device carried by a user.

11. The method of claim 1, wherein the user profile comprises information relating to internet use.

12. The method of claim 11, wherein information relating to internet use comprises information selected from the group consisting of web sites visited, the frequency of visits, and the duration of visits.

13. The method of claim 1, further comprising sending advertising content to a display device located within the communication network and that is visible to more than one user.

14. The method of claim 1, wherein designating demographic criteria comprises designating user criteria or ranges of user criteria.

15. The method of claim 1, further comprising storing the user profile at a central server and updating the user profile each time a user computer is logged on to the communications network.

16. The method of claim 1, wherein the advertising content is sent to the user computer through a wireless local area network.

17. A communications network comprising:
a central server;
a central server database storing a computer identifier and a user profile;
a router to facilitate a local TCP/IP network through which a user's computer may access the Internet;
wherein the user profile relates to personal attributes of said user of the communication network and the computer identifier identifies said user's computer, and
wherein the user profile is linked to the computer identifier.

18. The communications network of claim 17, wherein the user's computer comprises a device selected from the group consisting of personal computers, personal digital assistants, cellular telephones, video games, and MP3 players.

19. The communications network of claim 17, wherein the router comprises a commercially available router used to establish a Wi-Fi network.

20. The communications network of claim 17, wherein, after the user's computer has logged on to the communications network, the server is configured to send information to the user computer to allow a user to create a user profile, the user profile relating to personal attributes of the user.

21. The communications network of claim 17, wherein the server is configured to receive the computer identifier identifying the user computer when the user computer logs onto the communications network.

22. The communications network of claim 17, wherein the server is configured to match the user profile to the user computer using the computer identifier each time the user's computer logs onto the communication network.

23. The communications network of claim 17, wherein the server is configured to send information to an advertiser computer allowing an advertiser to designate demographic criteria for advertising content.

24. The communications network of claim 17, wherein the server is configured to send advertising content to the user's computer that is identified by a computer identifier that is correlated to the user profile that matches the demographic criteria.
